(19) United States
(12) Patent Application Publication
(10) Pub. No.: US 2012/0110912 A1
(43) Pub. Date: May 10, 2012

(54) HIGH STRENGTH MECHANISM INTERFACE

(75) Inventors: Michael PANOZZO, Bloomfield, MI (US); Evan KING, Ortonville, MI (US); Jolaine PRICE, Chesterfield, MI (US); Thomas MACK, Highland, MI (US)

(73) Assignee: Webasto Roof Systems Inc., Rochester Hills, MI (US)

(21) Appl. No.: 12/942,425

(22) Filed: Nov. 9, 2010

(51) Int. Cl. E05F 15/00

(52) U.S. Cl. 49/360

(57) ABSTRACT

A drive mechanism for a vehicle movable panel is provided having a drive cable coupled to a slide mechanism disposed within a guide track by a coupling interface. The coupling interface can include a rigid support structure connected to the drive cable, a composite over-mold, and at least one load bearing zone to spread the load from a high force event from the slide mechanism. A first load bearing zone can have a foot on the rigid support structure extended into a slot on the drive mechanism, but preferably can include a second load bearing zone having a pair of fore and aft tabs extending from the rigid support structure configured to generally abut internal edges a pair of fore and after sliding pads on the sliding mechanism, the fore and after tabs connected by an over-molded continuous load bearing member.

### FIELD

The present embodiments generally relate to movable panel applications for an opening of a vehicle (such as a sunroof), and particularly to a drive assembly for a movable panel having an interface between a drive cable and a slide mechanism within a guide track. The interface provides high strength and distribution of the transfer of energy load during sudden application of force through the use of a composite over-molded metal insert.

### BACKGROUND

In the art, sunroofs and other movable surfaces (“sunroofs”) installed to cover an opening of a vehicle roof are known. Through the years, various mechanisms have been developed to allow the sunroof to move and tilt. In some applications, a sunroof can be moved by the use of a drive mechanism disposed within a slide track attached to the vehicle. Often, the drive mechanism is moved by a drive cable attached to a motive force, such as a drive crank or a motor. Examples of such mechanisms generally are described in Webasto U.S. Pat. Nos. 6,595,081 “Drive for a displaceable motor vehicle part” and 6,582,014 “Sunroof mechanism and a rail assembly for the same”, the specifications of which are incorporated herein by reference.

In some embodiments, the sunroof panel can be mounted on a pair of guide track members that extend along an edge of the roof opening. A structural rail or modular frame may be provided in cooperating relation with the guide track members to provide attachment points for the guide tracks and for mounting of a motor for moving the sunroof panel via the slide mechanisms disposed within the guide tracks. Such sunroof mechanisms may also include a drive mechanism, such as an electric motor that drives a plurality of axially flexible compressively stiff drive cables, which can move the sunroof panel into different operative positions. The drive cable can be a helical spiral, and the like, and connected to each of a left and right slide mechanism and driven via a drive gear by a motor.

Although these sunroof panel drive mechanisms represent great advances in the art, further advances are possible and desired. For example, in many instances vehicle safety is tested through the use of application of a sudden force on various vehicle components to test its durability. This can include applying a significant amount of g-force on a component to simulate a vehicle crash. For the present descriptions contained herein the term g-force refers to a measure of the acceleration acting on a body measured in multiples of the sea level acceleration due to gravity on Earth, equating to ˜9.8 m/s².

In these types of embodiments the connection between the drive cable and the slide mechanism (“interface”) have been made of cast iron, injection molded plastics, or cast metal with noise insulators. The cast metal embodiments provide a high interface strength and allow small packaging, but are expensive, noisy, and do not provide superior wear during the life of the slide mechanism. Injection molded interface embodiments can provide a low cost, low noise, low wear, and small packaging solution, but can have lower strength than a metal interface. Cast metal interface embodiments with noise isolators can provide high strength, high expense, a large package, but low noise and low wear.

In the art, typical sunroof and other movable vehicle panel testing has occurred with the vehicle panel in a closed position. Known slide mechanisms for these panels have been satisfactorily tested at up to 50 g-force in a closed position. That is, the integrity of the drive mechanisms, including the cable/drive mechanism interface remained in-tact during the application of this force. Nevertheless, as government regulations may change, additional strength may be needed to provide a cable/drive mechanism interface that remains intact even when the roof panel is in an open or retracted position. This may be further problematic as roof panels evolve into increasingly larger sizes.

For example, FIG. 12 shows a composite cable/drive mechanism interface subjected to a 50 g-force on an open sunroof panel. As shown, the cable/drive mechanism interface did not remain in-tact. FIG. 13 shows a metal cable/drive mechanism without an over-molded interface (See, FIG. 3) subjected to a 50 g-force on an open sunroof panel with similar results. In the instance of the composite interface, the material did not provide sufficient strength to transfer load from the application of force. For the metal interface, the load was directed to a single connector tab, which also failed during testing.

### SUMMARY

Accordingly, there are provided herein embodiments of movable panel applications for an opening of a vehicle (such as a sunroof), and particularly to a drive assembly for a movable panel having an interface between a drive cable and a slide mechanism within a guide track. The interface provides high strength and distribution of transfer of energy load during sudden application of force through the use of a composite over-molded metal insert.

In one embodiment, a drive mechanism for a movable panel for a vehicle is provided having a drive cable coupled to a slide mechanism disposed within a guide track by a coupling interface. The coupling interface can include a rigid support structure connected to the drive cable, a composite over-mold, and at least one load bearing zone to spread the load from a high force event (i.e., greater than a 1 g-force) from the slide mechanism. The drive mechanism can have a rigid structure that transfers loading to a driving element, which can optionally have a composite over-mold on the rigid structure that can transfer loading to a driving element.

A first load bearing zone can have a foot on the rigid support structure interfacing with (e.g., extended into a slot on) the drive mechanism, but preferably can include a second load bearing zone having a pair of fore and aft tabs extending from the rigid support structure configured to generally abut internal edges a pair of fore and after sliding pads on the sliding mechanism, the fore and after tabs connected by an over-molded continuous load bearing member.

In an alternate embodiment, the second load bearing zone can be a pair of fore and aft tabs extending from the rigid support structure configured to generally abut the internal edges of a pair of fore and after sliding pads on the sliding mechanism, the fore and after tabs connected by a pair of generally parallel over-molded continuous load bearing members. Optionally, a generally perpendicular web connecting the parallel load bearing members may be included.

In preferred embodiments, the composite over-mold can be selected from the list consisting of acetal based plastics, fiberglass, nylons, cast aluminum, combinations thereof, and the like. Where the composite is an acetal based plastic, polyoxymethylene is preferred. In fiberglass composites, talc may optionally be used. As a further option, the composite can also be impregnated with lubricants, such as grease.

The support structure can be made from cold-rolled steel, stainless steel, combinations thereof, and the like. The support structure can be connected to drive cable by the steps of: curling an end of the support structure around the drive wire; crimping the curled support structure end to the drive wire; and over-molding the support structure with the composite.

Other features will become more apparent to persons having ordinary skill in the art which pertains from the following description and claims.

### BRIEF DESCRIPTION OF THE DRAWINGS

The foregoing features, as well as other features, will become apparent with reference to the description and Figures below, in which like numerals represent like elements, and in which:

FIG. 1 is a perspective view of an exemplary drive cable interface to a sliding mechanism of a movable panel of the present embodiments.

FIG. 2 is a perspective view of an exemplary drive cable interface to a sliding mechanism of the present embodiments showing an insert disposed within the over-mold component.

FIG. 3 is a perspective view of an exemplary drive cable interface to a slide mechanism of the present embodiments with the over-mold component removed.

FIG. 4 is a perspective view of an exemplary drive cable interface attached to a slide mechanism of a movable panel of the present embodiments.

FIG. 5 is a cross-sectional view of an exemplary drive cable interface to a slide mechanism of a movable panel of the present embodiments taken along section lines A-A in FIG. 2.

FIG. 6 is a perspective view of an exemplary drive cable interface attached to a slide mechanism of a movable panel of the present embodiments disposed within a guide track.

FIG. 7 is a perspective-sectional view of an exemplary drive cable interface attached to a slide mechanism of a movable panel of the present embodiments disposed within a guide track taken along section lines B-B in FIG. 6.

FIG. 8 is a side view of a preferred embodiment of an exemplary drive cable interface to a slide mechanism of a movable panel of the present embodiments.

FIG. 9 is a top view of a preferred embodiment of an exemplary drive cable interface to a slide mechanism of a movable panel of the present embodiments.

FIG. 10 is a side view of a preferred embodiment of an exemplary drive cable interface to a slide mechanism of a movable panel of the present embodiments.

FIG. 11 is a bottom view of a preferred embodiment of an exemplary drive cable interface to a slide mechanism of a movable panel of the present embodiments.

FIG. 12 is a photograph of a prior art composite drive cable interface to a slide mechanism of a movable panel after exposure to 50 g-force.

FIG. 13 is a photograph of a steel drive cable interface having a support frame structure without the over-molded component (FIG. 3) to a slide mechanism of a movable panel after exposure to 50 g-force.

### DETAILED DESCRIPTION OF THE EMBODIMENTS

The present embodiments provided movable panel applications for an opening of a vehicle (such as a sunroof). Particularly, the present embodiments provide a drive assembly for a movable panel having an interface between a drive cable and a slide mechanism within a guide track. The interface provides high strength and distribution of transfer of energy load during sudden application of force through the use of a composite over-molded metal insert. The present embodiments improve cable to mechanism interface without compromising package size, producing noise or wear concerns, or driving high cost.

In the past, the interface between a sunroof drive cable and sliding/actuation mechanisms within a guide track have been developed with a variety of manufacturing methods, such as casting, injection moldings, and the like. For reasons stated above, these types of interfaces have various problems of noise, wear, weakness, large package design, and the like. Generally, the present embodiments solve these problems by providing an injection molding over a support frame structure. This produces an interface solution that is cost effective, quiet, strong, wears well during the life of the product, and has an acceptable package size. The support frame is curled/rolled over and clamped onto the drive cable, then injection molded over the top of support structure. The injection molded material acts as an isolator to adjacent components while the support structure allows for increased loading on the drive system without damaging to injection molded material. Further, the injected over-mold component provides a better load distribution in the event of application of a sudden high g-force, such as a vehicle collision when the sunroof is deployed to an open position.

To aid in the understanding of the present embodiments, the following is described for an application for a sliding sunroof for a vehicle, though it is understood that the present embodiments may be applied to any number of movable surfaces for a variety of vehicles. It is also noted that for ease of understanding, the present embodiments are illustrated for only one side of the sunroof. It is understood that an additional “mirror image” mechanism is located on the opposite parallel side of the sunroof.

Generally, the sunroof mechanism can have a pair of guide track members that are constructed to be mounted to a roof at side edge portions of the roof opening. Each of the guide track members can have an elongated slide mechanism (drive member) receiving channel with a longitudinally extending opening. A sunroof panel assembly of a size to close the opening is movably received on within the guide track assembly by the slide mechanism disposed within the guide track. The slide mechanism and sunroof panel assembly are moveable with respect to the opening in the roof between an open position, wherein the panel member uncovers the opening and a closed position, wherein the panel member substantially closes the opening in the roof. Additional mechanisms with the slide can allow the sunroof panel to tilt relative to its orientation to the roof.

A pair of axially-flexible compressively-stiff drive cables are each coupled to the slide mechanism and can extend rearward to connect to a drive unit such as a crank or drive motor (not shown in the Figures). The drive unit is thus coupled to the slide mechanism and ultimately the sunroof by the pair of flexible drive cables. Each of the drive cables are coupled to the slide mechanism by the present embodiments as illustrated.

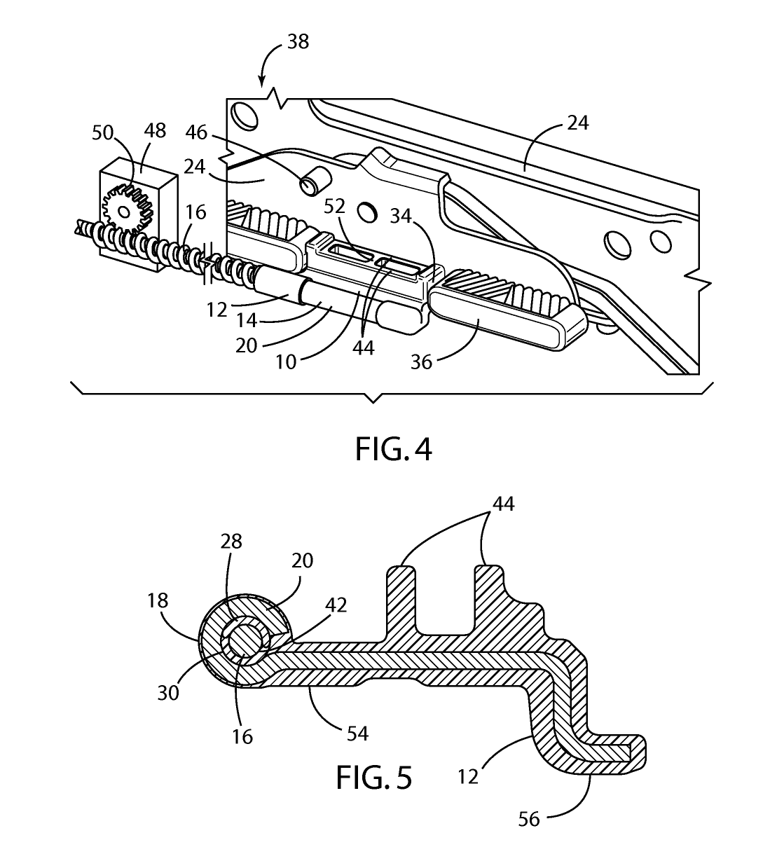

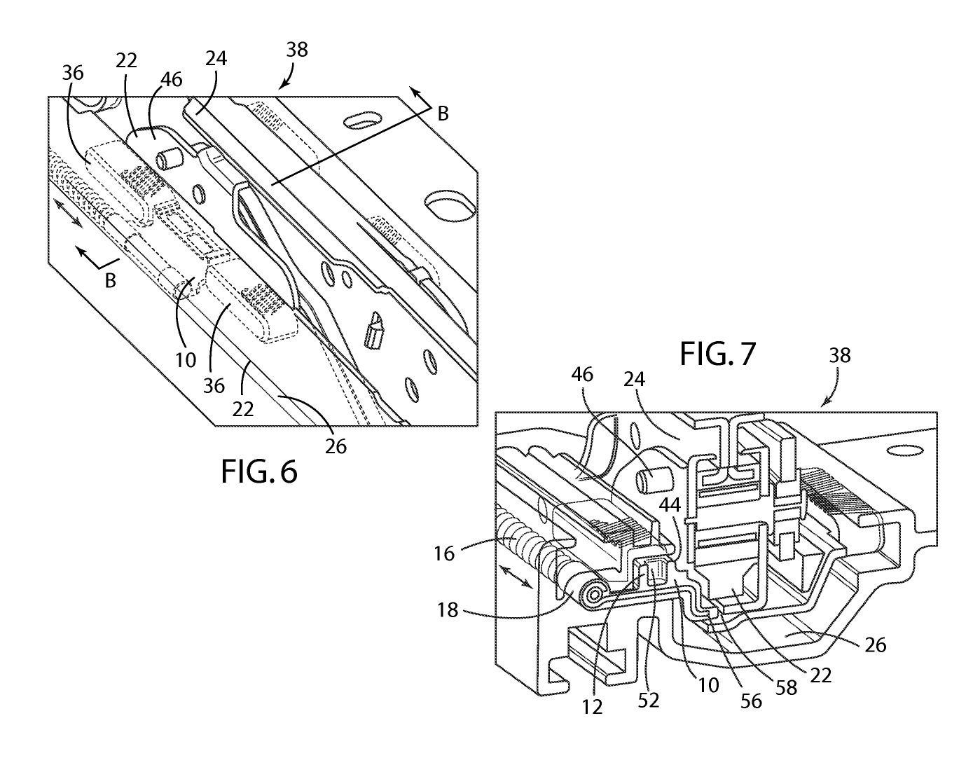

Turning now to the Figures there is illustrated a preferred embodiment of a coupling interface between a drive cable and slide mechanism of one side of a movable sunroof assembly. FIGS. 4, 6 and 7 illustrate a sunroof drive system generally indicated at 38 for the present embodiments. Again, the overall assembly would have a mirror image counterpart also running fore and aft (e.g., the direction of movement for the panel). The general drive system components 38 can include a drive cable 10 connected to slide mechanism 22. It is noted that drive cable 16 can have a helical wire overwrap 28 to engage a gear 50 of drive unit 48 (See, FIG. 4). Slide mechanism 22 can be disposed within guide track 26. Guide tracks 26 typically run fore and aft of a vehicle at least the length of travel of the sunroof. Slide mechanism 22 provides attachment points for a sunroof bracket 24 to hold a sunroof (not shown). Slide mechanism can also provide tilt features for the sunroof (See, tilt drive pin 46, FIGS. 4, 6-7).

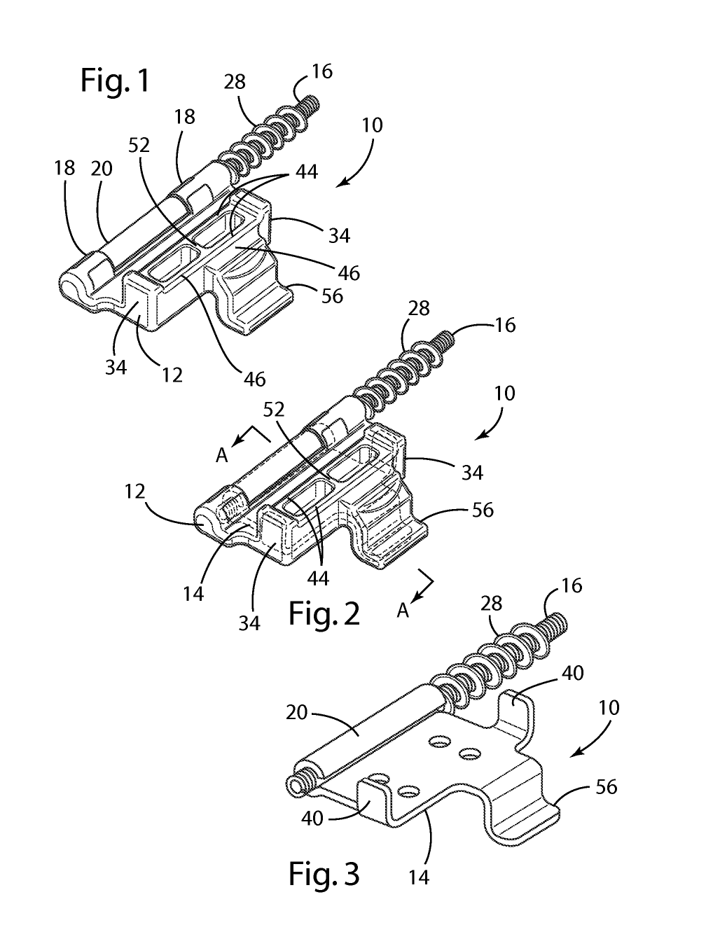

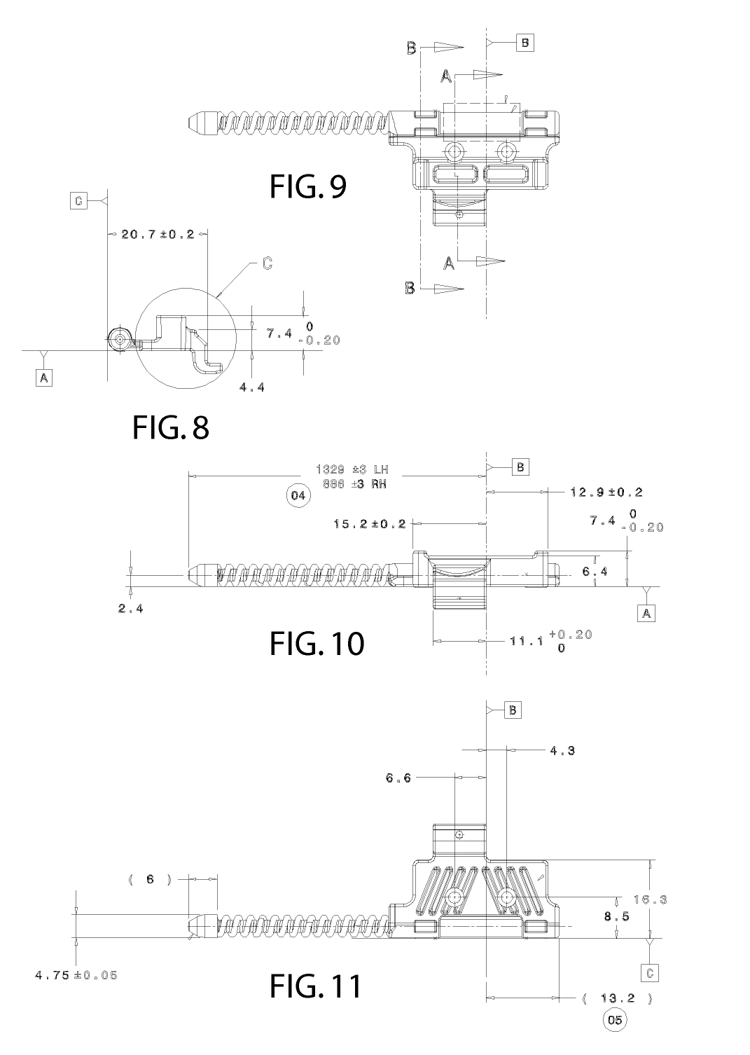

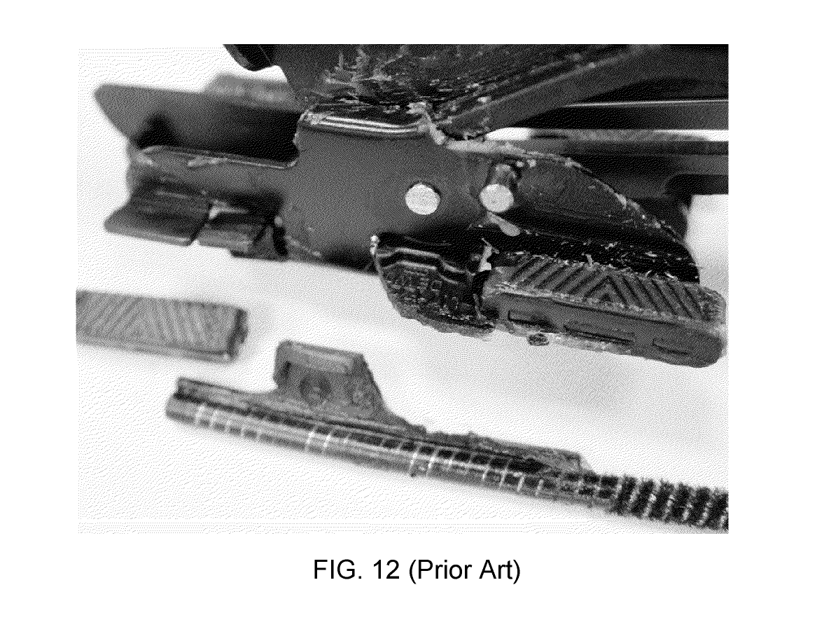

As shown in FIG. 4, interface 10 is used to couple drive cable 16 to slide mechanism 22. Interface 10 is generally indicated in FIGS. 1-3 coupled to a drive cable 16. FIG. 2 shows a support frame structure 14 disposed within an injection molded component 12 on interface 10, which is coupled to drive cable 16. A specific embodiment is illustrated in detail in FIGS. 8-11.

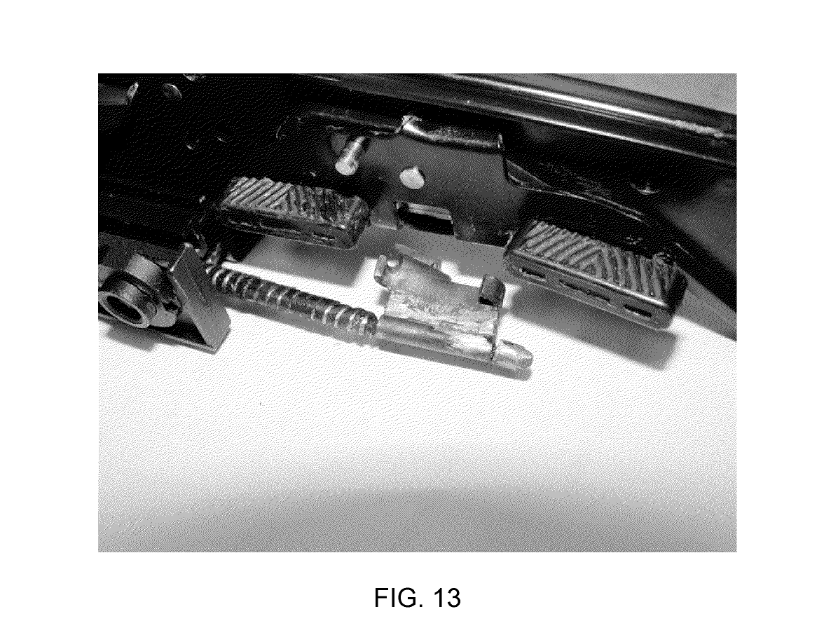

As shown more clearly in FIG. 3, support frame 14 provides a rigid and high strength platform for interface 10. Support frame 14, as illustrated, is curled around drive cable 16 at connection 20, then coupled to drive cable 16 by clamping, crimping, swedging, welding, gluing, combinations thereof, and the like. Support frame 14 can be made from various high strength materials such as cold rolled steel, stainless steel, combinations thereof, and the like. Preferably, support frame 14 is cold rolled steel and about 0.4 to 4 mm in thickness (preferably about 0.8 mm). Support frame 14 can have a foot 56 to slide into a slot 58 of slide mechanism 22 (FIG. 7) to couple drive cable 16. Holes 32 provide flow through points during the injection molding process to provide further bonding of the interface elements. Support frame structure 14 can also have tabs 40 on its edges that are forward and rearward of the vehicle where interface 10 can abut fore and aft slide pads 36 of slide mechanism 22 (See, FIG. 4). Tabs 40 provide additional strength and load bearing capability to interface 10. For example, impact testing of support frame 14 alone (FIG. 13) shows how both foot 56 and tabs 40 absorbed the impact load.

Once support frame 14 is curled/rolled over and clamped onto the drive cable 16, then the over-molded component 12 is injection molded over the top of support frame 14. The injection molded material 12 acts as an isolator to adjacent components, such as the slide mechanism and guide track, while allowing increased loading on the sunroof drive system without damaging to injection molded material, especially near tabs 40. Injected over-mold component 12 provides a better load distribution in the event of application of a sudden high g-force, such as a vehicle collision when the sunroof is deployed to an open position. The over-mold can cover the interface/drive cable connector 20 as well as the fore and aft area of drive cable 16. The over-mold injection can also penetrate into connector 20 (See, entry point 42 at FIG. 5) to encapsulate striated open areas of drive cable 16 (See, 30 at FIG. 5). As shown at 18 (FIG. 5) the over-molding can cover connector 20 as well. Further, over-molding can occur on an underside of interface 10 to provide a slide surface 54 to engage guide track 26. This provides improved wear and noise reduction when the slide mechanism is actuated.

Over-molded component 12 can cover tabs 40 to provide additional load distributing for the tabs of the support frame 14. As shown in FIG. 4, slide mechanism 22 can have slide pads 36 to provide a secondary contact point 34 to drive cable interface 10 (in addition to the primary contact point of the foot 56). As shown, contact point 34 is the internal edge of sliding pad 36. As illustrated, a pair of generally parallel load bearing members 44 can spread the load of the unit to the adjacent tab 40. A web 52 can be provided to add rigidity to the structure to reduce flexing and splaying of the over-molded component. The load bearing members 44 and web 52 produce recessed areas, which can aid in the molding process. Nevertheless, in an alternate embodiment, the recesses could be filled in with the composite to provide a single solid load bearing member 44. Slide pad 36 can also be made from a load distributing material such as described to over-molded component 12.

Thus, the present embodiments provide at least one load bearing component, namely the interface foot 56. Though preferably, as illustrated, there are two load bearing zones, namely interface foot 56 and the combinations of tabs 40 and load bearing member(s) 44. These load bearing zones are thus configured to receive and bear a load from a high force event from the slide mechanism. Thus, in the event of a vehicle impact that could supply, for example, up to a 50 g-force load on the drive mechanism, the load bearing zones would be able to spread the load to a point that the unit would remain in-tact and a sunroof, even in an open position, could remain attached to the vehicle.

Interface over-mold component 12 can be made from a variety of strong lightweight composite materials such as acetal based plastics. Acetal based plastics are chemically resistant, have very low water absorption, resistant to hydrolysis by base. A preferred over-mold component material is a Polyoxymethylene (commonly referred to as POM and also known as acetal, polyacetal or polyformaldehyde) sold under the trade name of DERLIN by DuPont. POM is used in precision parts that require high stiffness, low friction and excellent dimensional stability. Additional over-mold materials can include fiberglass. Where fiberglass is used, optionally Talc can be applied. Talc is an inexpensive filler used to extend resin and reduce shrinkage. Talc is a component in many fillers and faring compounds imparting excellent sanding properties. Other materials for the over-molded component 12 can include nylons, cast-aluminum, and the like. Optionally, the over-molded component can be impregnated with lubricants, such as grease and the like, to further reduce friction and wear as the product cycles through a guide track.

While the embodiments and methods have been described in conjunction with specific embodiments, it is evident that many alternatives, modifications, and variations will be apparent to those skilled in the art in light of the foregoing description.

We claim:

1. A drive mechanism for a movable panel for a vehicle, comprising:
a drive cable coupled to a slide mechanism disposed within a guide track by a coupling interface;
the coupling interface comprising
a rigid support structure connected to the drive cable,
a composite over-mold, and
at least one load bearing zone to spread the load from a high force event from the slide mechanism.

2. The drive mechanism of claim 1, comprising a load bearing zone of a foot on the rigid support structure interfacing with the drive mechanism.

3. The drive mechanism of claim 2, comprising a rigid structure that transfers loading to a driving element.

4. The drive mechanism of claim 2 comprising a composite overmold that transfers loading to a driving element.

5. The drive mechanism of claim 2, further comprising a second load bearing zone having a pair of fore and aft tabs extending from the rigid support structure configured to generally abut internal edges of a pair of fore and after sliding pads on the sliding mechanism, the fore and after tabs connected by an over-molded continuous load bearing member.

6. The drive mechanism of claim 5, further comprising a second load bearing zone having a pair of fore and aft tabs extending from the rigid support structure configured to generally abut internal edges of a pair of fore and after sliding pads on the sliding mechanism, the fore and after tabs connected by a pair of generally parallel over-molded continuous load bearing members.

7. The drive mechanism of claim 5, further comprising a generally perpendicular web connecting the parallel load bearing members.

8. The drive mechanism of claim 1, wherein the composite over-mold is selected from the list consisting of acetal based plastics, fiberglass, nylons, cast aluminum, and combinations thereof.

9. The drive mechanism of claim 8, wherein the composite is an acetal based plastic of polyoxymethylene.

10. The drive mechanism of claim 8, wherein the composite is fiberglass.

11. The drive mechanism of claim 10, wherein the fiberglass further comprises Talc.

12. The drive mechanism of claim 8, wherein the composite is further impregnated with lubricant.

13. The drive mechanism of claim 1, wherein the support structure is cold-rolled steel.

14. The drive mechanism of claim 1, wherein the support structure is connected to drive cable by the steps of:
curling an end of the support structure around the drive wire;
crimping the curled support structure end to the drive wire; and
over-molding the support structure with the composite.

15. The drive mechanism of claim 1, wherein the high force event is greater than 1 g-force.
